(19) United States
(12) Patent Application Publication
(10) Pub. No.: US 2009/0111327 A1
(43) Pub. Date: Apr. 30, 2009

(54) HDMI snap-in coupler

(76) Inventors: Ching Wen Weng, Taipei City (TW); Chiao Lan Yeh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/976,632

(22) Filed: Oct. 26, 2007

(51) Int. Cl. H01R 25/00; H01R 13/648

(52) U.S. Cl. 439/638; 439/607

(57) ABSTRACT

The present invention relates to a HDMI snap-in coupler, which comprises a circuit board, a first HDMI connection port module, a second HDMI connection port module, a top housing, and bottom housing. The first and second HDMI connection port modules are set on the circuit board. The top housing accommodates the circuit board, and the first and second HDMI connection port modules. The top housing has a first opening. The first HDMI connection port module is placed in the first opening. The bottom housing lodges in the top housing and has a second opening. The second HDMI connection port module is placed in the second opening. The present invention provides a HDMI snap-in coupler with double-side HDMI interfaces suitable for installing on current common socket panels (such as: information panels or multimedia information panels) without the need of modifying the design of the socket panels. Thereby, market universality and integration purposes can be achieved. The HDMI snap-in coupler according to the present invention can be installed movably on a socket panel, and can be replaced with ease. Besides, the HDMI snap-in coupler according to the present invention has the characteristic of miniaturization.

### FIELD OF THE INVENTION

The present invention relates generally to a HDMI snap-in coupler, and particularly to a HDMI snap-in coupler with double-side HDMI interfaces.

### BACKGROUND OF THE INVENTION

Currently, the high definition multimedia interface (HDMI) has rapidly become the standard of digital interface for global consumer electronic products. From digital TVs to DVDs, products with an HDMI interface have spread all over the world, bringing more digital enjoyment for consumers. According to the regulation of FCC of the United States, all peripheral products of digital TVs must have a built-in digital visual interface (DVI) or an HDMI interface. No matter LCD TVs, plasma TVs, projection TVs, DVD players, or next-generation DV players, they all have a built-in HDMI interface.

Up to now, the signal interface between a computer and a display is still mainly conventional analog interface. The liquid crystal display receives the analog signals transmitted from the video cable via the video interface and converts them into digital signals. Thereby, the signal conversion loss is huge, and the transmission distance is kept around 2 to 3 meters. In addition, because digital signals have to be converted into analog signals, more costs have to be spent. Accordingly, the DVI interface is developed. The DVI interface uses a small-amplitude differential transmission technology. By maintaining image signals as digital signals and transmitting to one side of the display, extremely high image quality is given. Besides, the transmission distance is extended to 10 to 20 meters. However, because the volume of the DVI connector is relatively large and audio signals are not compatible with DVI, its applications is mainly limited to image data transmission between the computer and display. In order to improve the DVI interface, the HDMI interface is developed. The HDMI interface is based on the DVI interface. By the HDMI interface, digital audio signals can be transmitted, and the protection for high-bandwidth digital contents is supported. Thereby, the HDMI interface is regarded as the standard digital interface for next-generation home theater applications. In comparison with the DVI connector, an HDMI connector is relatively smaller, and only one cable is needed for adding audio signals and control signals between equipments in addition to the original video signals. Furthermore, the HDMI interface also supports the luminance and color difference signal format used in traditional televisions. Thus, the conventional video color processing technology can be adopted completely. The interface is loaded with digital content protection technologies too for preventing illegal duplication of digital signals and image data.

Nevertheless, current HDMI connectors are not suitable for the common socket panels. To install an HDMI connector on a socket panel, the design of the current socket panel has to be changed. Besides, if an HDMI connector is to be installed in home, the original socket panel needs to be replaced by a socket panel suitable for the HDMI connector. In order to improve the problem described above, the present invention provides a HDMI snap-in coupler with double-side HDMI interfaces that can be installed on current common socket panels.

### SUMMARY

An objective of the present invention is to provide a HDMI snap-in coupler with double-side HDMI interfaces. Besides, the HDMI snap-in coupler according to the present invention has the characteristic of miniaturization.

An objective of the present invention is to provide a HDMI snap-in coupler that can be installed on a common socket panel, achieving market universality and integration purposes.

An objective of the present invention is to provide a HDMI snap-in coupler that can be installed movably on a socket panel, and can be replaced with ease.

In order to achieve the objectives described above, the present invention provides a HDMI snap-in coupler, which comprises a circuit board, a first HDMI connection port module, a second HDMI connection port module, a top housing, and a bottom housing. The first HDMI connection port module is set on one side of the circuit board; the second HDMI connection port module is set on the other side of the circuit board. The top housing has a first opening, and the first HDMI connection port module is adapted in the first opening. The bottom housing is lodged in the top housing, and has a second opening, and the second HDMI connection port module is adapted in the second opening. The HDMI snap-in coupler can be installed on a socket panel such as an information panel or a multimedia information panel.

The first HDMI connection port module (the second HDMI connection port module) comprises a sheltering shell, an insulating base, a spacer plate, and a plurality of terminals. The plurality of terminals is adapted on the spacer plate, which is set on the insulating base. The sheltering shell accommodates the spacer plate with the plurality of terminals and the insulating base. When the first HDMI connection port module (the second HDMI connection port module) is set on the circuit board, a conducting wire is used for connecting electrically the circuit board and the first HDMI connection port module (the second HDMI connection port module).

### BRIEF DESCRIPTION OF THE DRAWINGS

FIG. 1A shows a three-dimensional exterior view according to a preferred embodiment of the present invention;

FIG. 1B shows a three-dimensional exterior view from another viewing angle according to a preferred embodiment of the present invention;

FIG. 2A shows an assembly diagram of a circuit board and two HDMI connection port modules according to a preferred embodiment of the present invention;

FIG. 2B shows an assembly diagram of a circuit board and two HDMI connection port modules according to another preferred embodiment of the present invention;

FIG. 3 shows an exploded view of an HDMI connection port module according to a preferred embodiment of the present invention;

FIG. 4A shows an exploded view according to another preferred embodiment of the present invention;

FIG. 4B shows an exploded view from another viewing angle according to another preferred embodiment of the present invention;

FIG. 4C shows a three-dimensional exterior view according to another preferred embodiment of the present invention; and

FIG. 4D shows a schematic diagram showing a HDMI snap-in coupler installed on a socket panel according to another preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

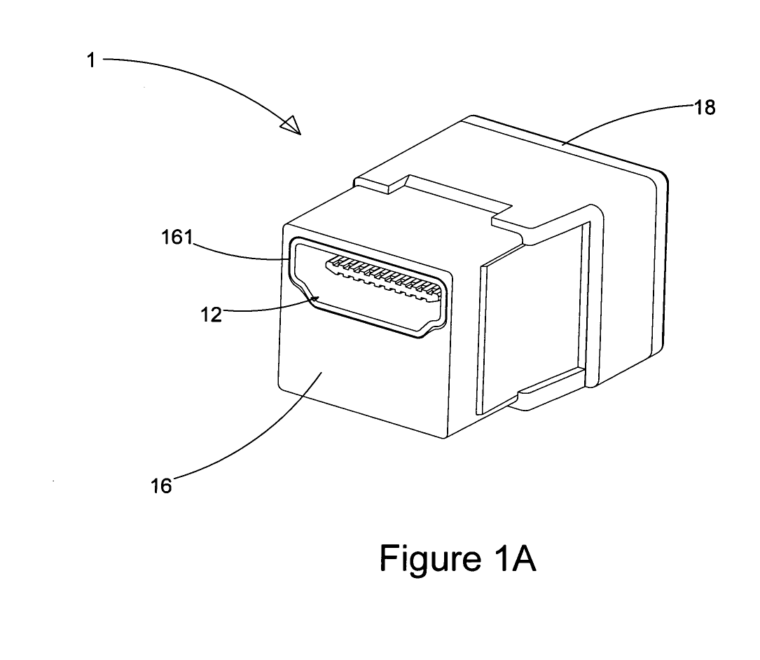

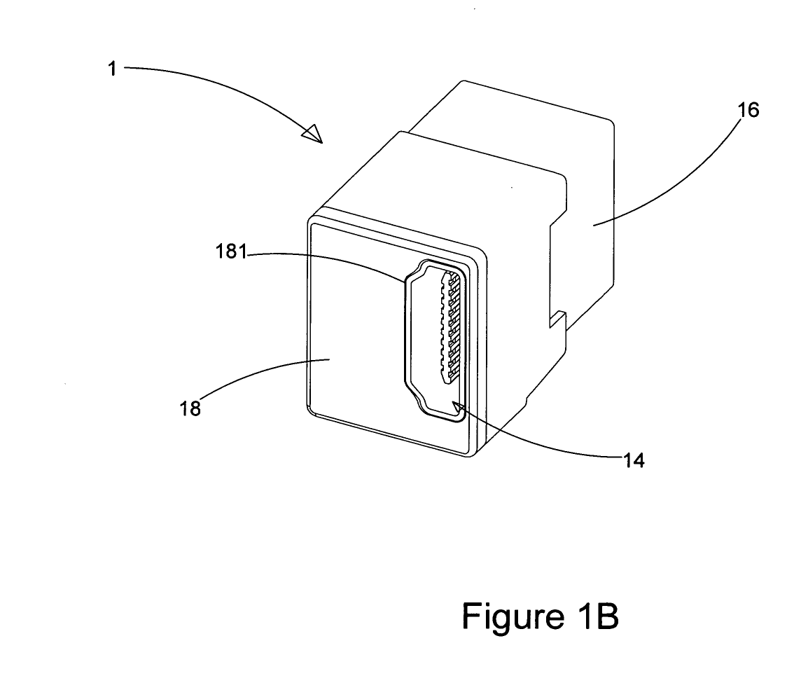

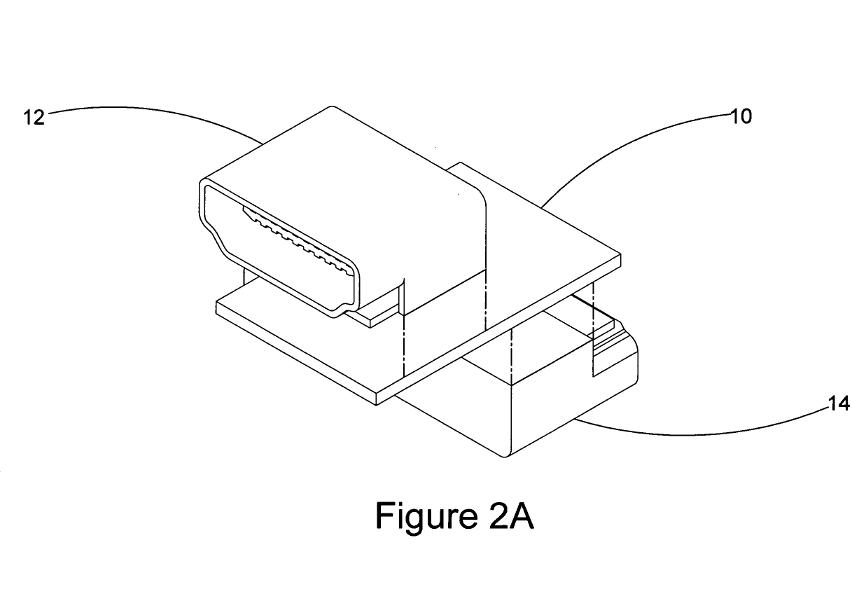

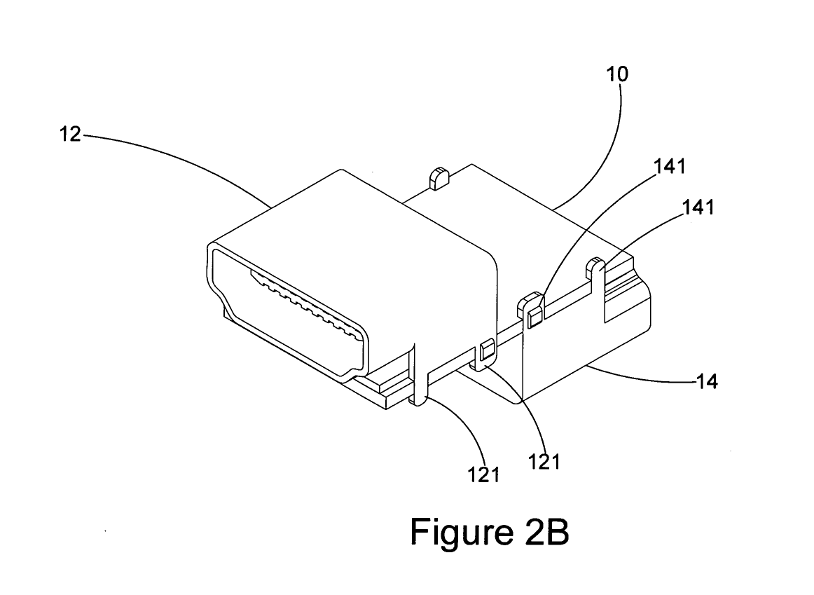

FIGS. 1A, 1B, and 2A show a three-dimensional exterior view, a three-dimensional exterior view from another viewing angle, and an assembly diagram of a circuit board and two HDMI connection port modules according to a preferred embodiment of the present invention, respectively. As shown in the figures, the present invention provides a HDMI snap-in coupler 1, which comprises a circuit board 10, a first HDMI connection port module 12, a second HDMI connection port module 14, a top housing 16, and a bottom housing 18. As shown in FIG. 2A, the circuit board 10 is adapted between the first and second HDMI connection port module 12, 14. The first HDMI connection port module 12 is bonded on one side of the circuit board 10; the second HDMI connection port module 14 is bonded on the other side of the circuit board 10, and is opposite to the first HDMI connection port module 12. The top housing 16 accommodates the circuit board 10, the first HDMI connection port module 12, and the second HDMI connection port module 14. The top housing 16 has a first opening 161, and the first HDMI connection port module 12 is adapted in the first opening 161. The bottom housing 18 is lodged in the top housing 16 and has a second opening 181, and the second HDMI connection port module 14 is adapted in the second opening 181. The HDMI snap-in coupler 1 can be installed on a socket panel such as an information panel or a multimedia information panel. The assembly method of the top housing 16 and the bottom housing 18 includes lodging as described above, or supersonic assembly.

FIG. 2B shows an assembly diagram of a circuit board and two HDMI connection port modules according to another preferred embodiment of the present invention. As shown in the figure, according to the previous preferred embodiment, the first and second HDMI connection port modules 12, 14 are bonded to the circuit board 10. However, in the present preferred embodiment, in order to increase replacement capability of components, one or more hooks 121, 141 are adapted on the first and second HDMI connection port modules 12, 14, respectively. The first and second HDMI connection port modules 12, 14 use the hooks 121, 141 to lodge on the circuit board 10, respectively. When the first HDMI connection port module 12 or the second HDMI connection port module 14 is damaged, a new HDMI connection port module can replace the damaged one with ease.

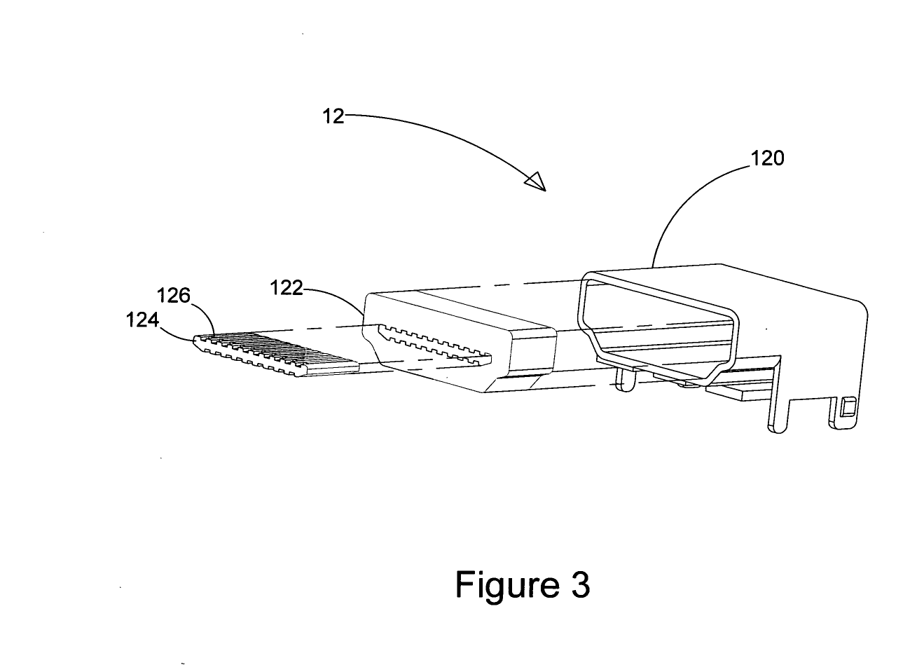

FIG. 3 shows an exploded view of an HDMI connection port module according to a preferred embodiment of the present invention. As shown in the figure, the structure of the HDMI connection port module according to the present invention is disclosed. The structure of the first HDMI connection port module 12 is the same as that of the second HDMI connection port module 14. Thereby, one of said HDMI connection port modules is used as an example for description. The first HDMI connection port module 12 (the second HDMI connection port module 14) comprises a sheltering shell 120, an insulating base 122, a spacer plate 124, and a plurality of terminals 126. The plurality of terminals 126 is adapted on the spacer plate 124, which is set on the insulating base 122. The sheltering shell 120 accommodates the spacer plate 124 with the plurality of terminals 126 and the insulating base 122. When the first HDMI connection port module 12 (the second HDMI connection port module 14) is set on the circuit board 10 described in the previous preferred embodiment, a conducting wire is used for connecting electrically the circuit board 10 and the first HDMI connection port module 12 (the second HDMI connection port module 14).

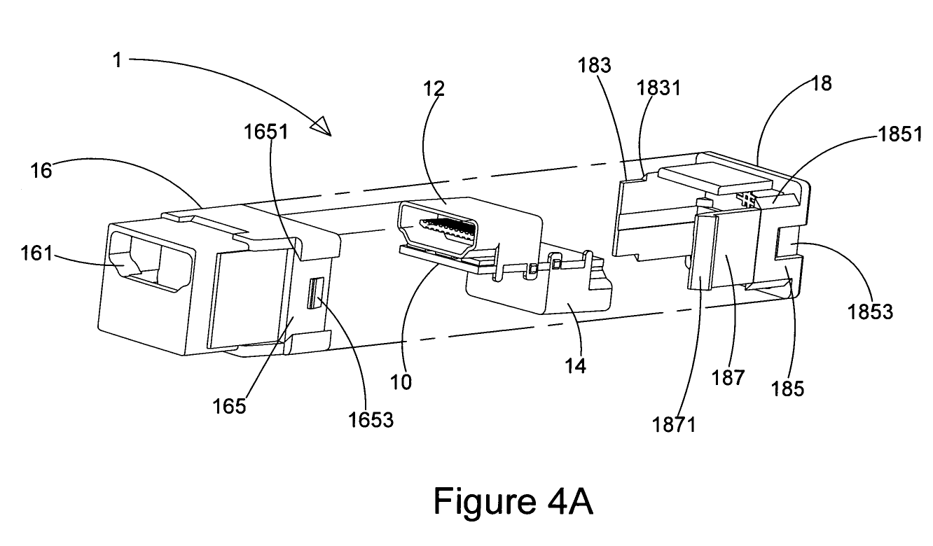

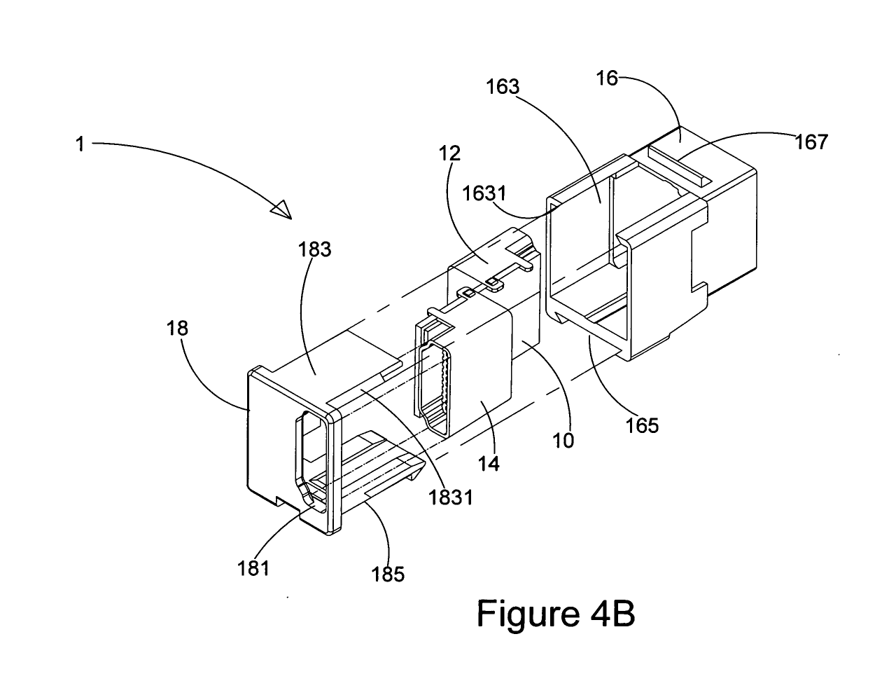

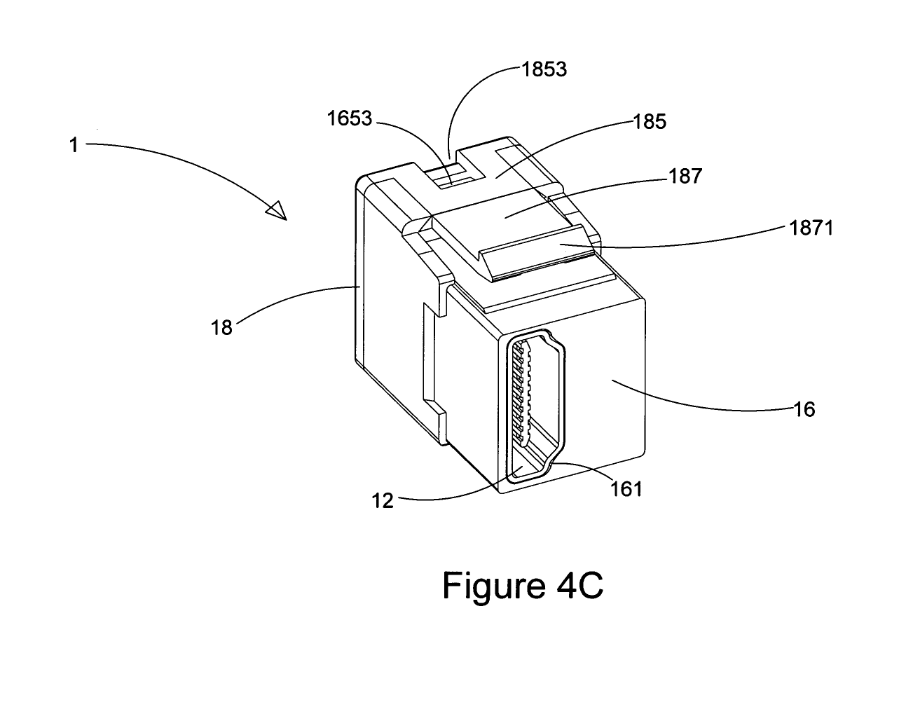

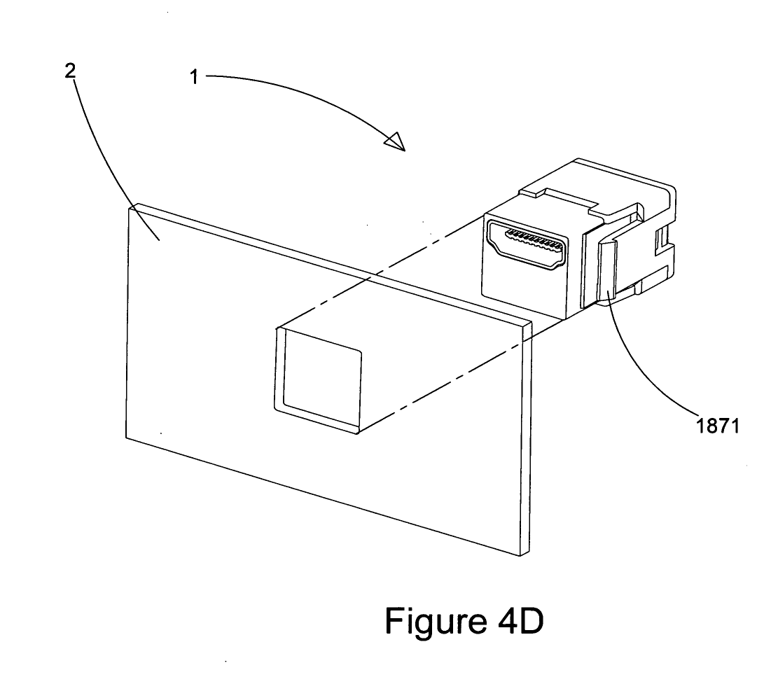

FIG. 4A shows an exploded view, an exploded view from another viewing angle, a three-dimensional exterior view, and a schematic diagram showing a HDMI snap-in coupler installed on a socket panel according to another preferred embodiment of the present invention, respectively. As shown in the figures, the present invention provides a HDMI snap-in coupler 1, which comprises a circuit board 10, a first HDMI connection port module 12, a second HDMI connection port module 14, a top housing 16, and a bottom housing 18. The circuit board 10 is adapted between the first and second HDMI connection port module 12, 14. The first HDMI connection port module 12 is lodged on one side of the circuit board 10; the second HDMI connection port module 14 is lodged on the other side of the circuit board 10, and is opposite to the first HDMI connection port module 12. The circuit board 10, on which the first HDMI connection port module 12 and the second HDMI connection port module 14 are set, is placed in the top housing 16. The top housing 16 has a first opening 161, and the first HDMI connection port module 12 is adapted in the first opening 161. The bottom housing 18 is lodged in the top housing 16 and has a second opening 181, and the second HDMI connection port module 14 is adapted in the second opening 181. The difference between the present preferred embodiment and the one in FIG. 1 is that in the present one, the top housing 16 has a breach 163 and a trench 165. The breach 163 faces the trench 165. In addition, the bottom housing 18 has a first sidewall 183 and a second sidewall 185. The first sidewall 183 lodges in the breach 163, while the second sidewall 185 lodges in the trench 165. Thereby, the bottom housing 18 lodges in the top housing 16.

In order to enhance assembly firmness of the top and bottom housings 16, 18, first inclined planes 1631 are set on both inner sidewalls of the breach 163 of the top housing 16, respectively. Besides, second inclined planes 1831 are set on both inner sidewalls of the first sidewall 183 of the bottom housing 18. The first inclined planes 1631 face the second inclined planes 1831. Third inclined planes 1651 are set on both inner sidewalls of the trench 165. And fourth inclined planes 1851 are set on the both inner sidewalls of the second sidewall 185 of the bottom housing 18. The third inclined planes 1651 face the fourth inclined planes 1851. In addition, a first protruding part 1653 can be further set in the trench 165, and a hole 1853 can be set on the second sidewall 185. When the second sidewall 185 lodges in the trench 165, the first protruding part 1653 lodges in the hole 1853.

The HDMI snap-in coupler 1 can be installed on a socket panel 2 such as an information panel or a multimedia information panel. To replace the HDMI snap-in coupler 1 easily, the HDMI snap-in coupler 1 can be set on the socket panel 2 movably. The surface on the bottom housing 18 with the breach 163 has a second protruding part 167. The second sidewall 185 of the bottom housing 18 has an elastic sheet 187, on which elastic sheet 187 a third protruding part 1871 is set. When the elastic sheet 187 is pressed, the HDMI snap-in coupler 1 is placed into the socket panel 2, and the side of the HDMI snap-in coupler 1 with the second protruding part 167 lodges in one side of the socket panel 2. When the elastic sheet 187 is released, the third protruding part 1871 set on the elastic sheet 187 lodges in the other side of the socket panel 2. The elastic sheet 187, the third protruding part 1871, and the second sidewall 185 can be formed integrally.

To sum up, the present invention provides a HDMI snap-in coupler with double-side HDMI interfaces suitable for installing on current common socket panels (such as: information panels or multimedia information panels) without the need of modifying the design of the socket panels. Thereby, market universality and integration purposes can be achieved. The HDMI snap-in coupler according to the present invention can be installed movably on a socket panel, and can be replaced with ease. Besides, the HDMI snap-in coupler according to the present invention has the characteristic of miniaturization.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A HDMI snap-in coupler, comprising:
a circuit board;
a first HDMI connection port module, set on one side of the circuit board;
a second HDMI connection port module, set on the other side of the circuit board, and opposite to the location of the first HDMI connection port module;
a top housing, accommodating the circuit board, the first HDMI connection port module, and the second HDMI connection port module, having a first opening, and the first HDMI connection port module being in the first opening; and
a bottom housing, set on the top housing, having a second opening, and the second HDMI connection port module being in the second opening.

2. The HDMI snap-in coupler of claim 1, wherein the first HDMI connection port module comprises:
a sheltering shell;
an insulating base, set in the sheltering shell;
a spacer plate, set on the insulating base; and
a plurality of terminals, set on the spacer plate.

3. The HDMI snap-in coupler of claim 1, wherein the second HDMI connection port module comprises:
a sheltering shell;
an insulating base, set in the sheltering shell;
a spacer plate, set on the insulating base; and
a plurality of terminals, set on the spacer plate.

4. The HDMI snap-in coupler of claim 1, wherein the first HDMI connection port module and the second HDMI connection port module are bonded on the circuit board.

5. The HDMI snap-in coupler of claim 1, wherein the first HDMI connection port module further has one or more hooks, and the first HDMI connection port module lodges on the circuit board.

6. The HDMI snap-in coupler of claim 1, wherein the second HDMI connection port module further has one or more hooks, and the second HDMI connection port module lodges on the circuit board.

7. The HDMI snap-in coupler of claim 1, wherein the top housing has breach, the bottom housing has a first sidewall, and the first sidewall lodges in the breach.

8. The HDMI snap-in coupler of claim 7, wherein first inclined planes are set on both inner sidewalls of the breach, respectively, second inclined planes are set on both inner sidewalls of the first sidewall, respectively, and the first inclined planes face the second inclined planes.

9. The HDMI snap-in coupler of claim 8, wherein the top housing has a trench facing the breach, the bottom housing has a second sidewall facing the first sidewall, and the sidewall lodges in the trench.

10. The HDMI snap-in coupler of claim 9, wherein the third inclined planes are set on both inner sidewalls of the trench, fourth inclined planes are set on the both inner sidewalls of the second sidewall, and the third inclined planes face the fourth inclined planes.

11. The HDMI snap-in coupler of claim 9, wherein a first protruding part is further set in the trench of the top housing, and a hole is set on the second sidewall of the bottom housing, and the first protruding part lodges in the hole.

12. The HDMI snap-in coupler of claim 9, wherein the HDMI snap-in coupler is installed on a socket panel.

13. The HDMI snap-in coupler of claim 12, wherein the surface on the bottom housing with the breach has a second protruding part, the second sidewall of the bottom housing has an elastic sheet, on which elastic sheet a third protruding part is set, and the second protruding part and the third protruding part lodge in the socket panel.

14. The HDMI snap-in coupler of claim 12, wherein the socket panel comprises an information panel or a multimedia information panel.
